(19) United States
(12) Patent Application Publication
(10) Pub. No.: US 2024/0261675 A1
(43) Pub. Date: Aug. 8, 2024

(54) A Concept for Controlling Parameters of a Hypervisor

(71) Applicant: Intel Corporation, Santa Clara, CA (US)

(72) Inventors: Minggui CAO, Shanghai (CN); Jian Jun CHEN, Shanghai (CN); Qian OUYANG, Shanghai (CN); Yi QIAN, Shanghai (CN); Junjun SHAN, Shanghai (CN); Xiangyang WU, Shanghai (CN)

(21) Appl. No.: 18/570,109

(22) PCT Filed: Oct. 14, 2021
(86) PCT No.: PCT/CN2021/123825

§ 371 Date: Dec. 14, 2023

(51) Int. Cl. A63F 13/355; A63F 13/335; H04L 67/568

(52) U.S. Cl. CPC A63F 13/355; A63F 13/335; H04L 67/568; A63F 2300/538

(57) ABSTRACT

A control apparatus (10), control device, control method and computer program for controlling one or more parameters of a hypervisor (100) and an apparatus, device, method, and computer program for a virtual machine (200). The control apparatus (10) comprises circuitry configured to obtain information on respective performance targets of two or more virtual machines (200) being hosted by the hypervisor (100). The circuitry is configured to set the one or more parameters of the hypervisor (100) to one or more initial values. The circuitry is configured to obtain respective results of a benchmark being run in the two or more virtual machines (200), the results of the benchmark indicating a performance of the respective virtual machines (200) with respect to the respective performance targets, with the results of the benchmark being affected by the one or more parameters. The circuitry is configured to adjust the one or more parameters based on the results of the benchmark and based on the respective performance targets. The circuitry is configured to repeat obtaining the respective results of the benchmark and adjusting the one or more parameters until a termination condition is met.

### BACKGROUND

Workload consolidation (WLC) systems become increasingly popular in edge and industrial computing. Some WLC systems that are based on a VMM (Virtual Machine Monitor), like ACRN (an open-source reference hypervisor), are well adopted in the industry. A typical use case includes one HMI (Human-Machine-Interface, such as Microsoft Windows or the Android Operating System) Virtual Machine (VM), one RTVM (Real-Time Virtual Machine, such as Preempt Linux or another Real-Time Operating System (RTOS) as real-time VM) and some other VMs. In many cases, the HMI VM runs some configuration applications that have a User Interface (UI), while the RTVM runs some real-time tasks, like device controlling. But as use cases vary for different users, there is some effort for customizing the configurations to meet the user's requirements.

For example, some users may desire to run vision Al (Artificial Intelligence) or more tasks on the HMI VM and just require a “soft” real-time task in RTVM. Other customers may desire to run a simple configuration tool in the HMI VM but may require a “hard” real time task in the RTVM. In WLC systems, the hardware resources are shared between the VMs. Consequently, the VMs may interfere with each other. It takes a developer time to tune the parameter configurations (like Cache Allocation (CAT), Central Processing Unit (CPU)/Graphics Processing Unit (GPU) frequency etc.) to meet the respective user's KPI (Key Performance Indicator). If more devices or parameters are controlled, the effort for adjusting the parameters may be increased further.

Some providers of WLC system offer a set of tools, which can be used for real-time configuration and optimization, time synchronization and communication, and measurement and analysis. In WLC systems, such tools are sometimes used in the RTVM to ensure the VM fulfills the real-time requirement. However, such tools are only used in one domain (RTVM), and they cannot support optimization across domains, e.g., of the HMI VM, the RTVM VM and the hypervisor. Also, such tools usually cannot provide a balanced “KPI” configuration between the HMI VM and the RTVM VM.

### BRIEF DESCRIPTION OF THE FIGURES

Some examples of apparatuses and/or methods will be described in the following by way of example only, and with reference to the accompanying figures, in which

FIG. 1a shows a block diagram of an example of a control apparatus or a control device for controlling one or more parameters of a hypervisor;

FIG. 1b shows a block diagram of an example of a server comprising a hypervisor that is configured to host virtual machines;

FIG. 1c shows a flow chart of an example of a control method for controlling one or more parameters of a hypervisor;

FIG. 2a shows a block diagram of an example of an apparatus or device for a virtual machine and of a virtual machine comprising the apparatus or device;

FIG. 2b shows a flow chart of an example of a method for a virtual machine;

FIG. 3 shows a schematic diagram of a high-level system overview; and

FIG. 4 shows a flow chart of an example of a tuning workflow.

### DETAILED DESCRIPTION

Some examples are now described in more detail with reference to the enclosed figures. However, other possible examples are not limited to the features of these examples described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an ‘or’, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but embodiments of the technologies described herein may be practiced without these specific details. Well-known circuits, structures, and techniques have not been shown in detail to avoid obscuring an understanding of this description. “An embodiment/example,” “various embodiments/example,” “some embodiments/example,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an embodiment/example,” “in embodiments/example,” “in some embodiments/examples,” and/or “in various embodiments/examples,” each of which may refer to one or more of the same or different embodiments or examples. Furthermore, the terms “comprising,” “including,” “having,” and the like, as used with respect to embodiments of the present disclosure, are synonymous.

Various examples of the present disclosure relate to a concept for a self-adaptive tuning method for different user WLC requirements in a VMM. The proposed concept may be used to automatically conduct configuration adjustment, profiling, and tunning to achieve different user requirements, for example.

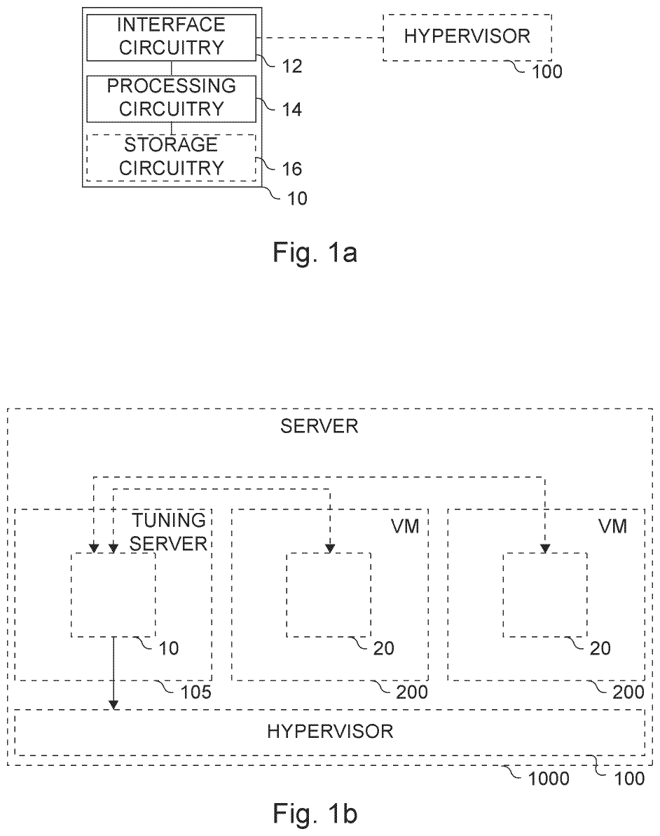

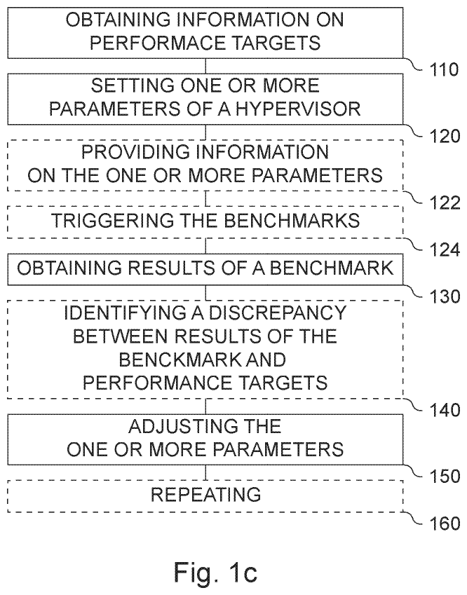

FIG. 1a shows a block diagram of an example of a control apparatus 10 or a control device 10 for controlling one or more parameters of a hypervisor. The control apparatus 10 comprises circuitry that is configured to provide the functionality of the control apparatus 10. For example, the control apparatus 10 may comprise interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the control apparatus, in conjunction with the interface circuitry 12 (for exchanging information, e.g., with a hypervisor 100 or with two or more virtual machines 200) and the storage circuitry (for storing information) 16. Likewise, the control device may comprise means that is/are configured to provide the functionality of the control device 10. The components of the control device 10 are defined as component means, which may correspond to, or implemented by, the respective structural components of the control apparatus 10. For example, the control device 10 may comprise means for processing 14, which may correspond to or be implemented by the processing circuitry 14, means for communicating 12, which may correspond to or be implemented by the interface circuitry 12, and means for storing information 16, which may correspond to or be implemented by the storage circuitry 16.

The circuitry or means is/are configured to obtain information on respective performance targets of two or more virtual machines 200 being hosted by the hypervisor. The circuitry or means is/are configured to set the one or more parameters of the hypervisor to one or more initial values. The circuitry or means is/are configured to obtain respective results of a benchmark being run in the two or more virtual machines. The results of the benchmark indicate a performance of the respective virtual machines with respect to the respective performance targets. The results of the benchmark are affected by the one or more parameters. The circuitry or means is/are configured to adjust the one or more parameters based on the results of the benchmark and based on the respective performance targets. For example. the circuitry or means may be configured to repeat obtaining the respective results of the benchmark and adjusting the one or more parameters until a termination condition is met.

In general, a hypervisor (also denoted “virtual machine manager” VMM), such as the hypervisor 100, is a computer component that is configured to run (i.e., execute) virtual machines. A hypervisor may be implemented using software, firmware and/or hardware or using a combination thereof. A computer comprising a hypervisor that is used to run one or more virtual machines is usually called a host computer, with the virtual machines being called the guests of the host computer. For example, the hypervisor 100 may be part of a host computer, such as a server computer. FIG. 1b shows a block diagram of an example of a server 1000 comprising the hypervisor 100 being configured to host virtual machines 105; 200.

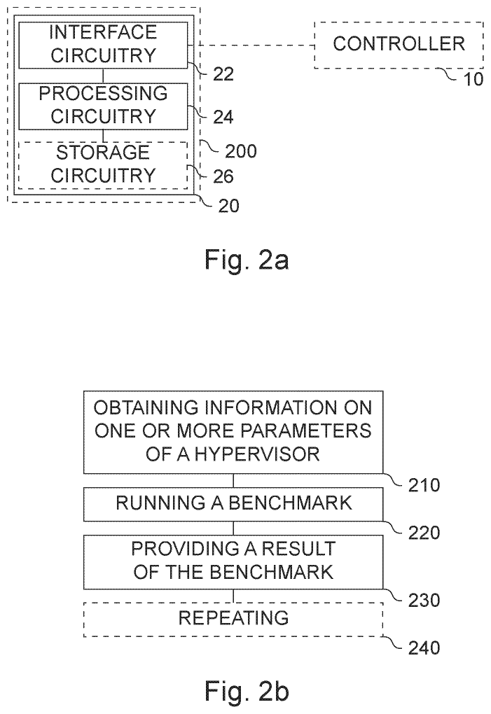

In FIG. 1b, two different types of virtual machines are shown—a first type (denoted “tuning server” 105) that comprises the control apparatus or control device 10, and a second type (denoted “VM”, Virtual Machine) that corresponds to the two or more virtual machines 200 being hosted by the hypervisor. Accordingly, the functionality of the control apparatus or control device 10 may be provided by a further virtual machine 105 being hosted by the hypervisor 100. FIG. 1b shows a system comprising the control apparatus 10 (as part of the further virtual machine 105) and the hypervisor 100. For example, the system may further comprise two or more apparatuses or devices 20 that will be introduced in connection with FIG. 2a. For example, as shown in FIG. 1b, the two or more apparatuses 20 may be implemented in the two or more virtual machines 200 being hosted by the hypervisor. For example, FIG. 1b further shows a system comprising the control apparatus 10 and two or more apparatuses 20. FIG. 1c shows a flow chart of an example of a corresponding control method for controlling the one or more parameters of the hypervisor. The method comprises obtaining 110 the information on the respective performance targets of the two or more virtual machines being hosted by the hypervisor. The method comprises setting 120 the one or more parameters of the hypervisor to the one or more initial values. The method comprises obtaining 130 the respective results of a benchmark being run in the two or more virtual machines. The method comprises adjusting 150 the one or more parameters based on the results of the benchmark and based on the respective performance targets. The method may comprise repeating 160 obtaining 130 the respective results of the benchmark and adjusting 150 the one or more parameters until the termination condition is met.

In the following, the functionality of the control apparatus 10, the control device 10, the control method and of a corresponding computer program is introduced in connection with the control apparatus 10. Features introduced in connection with the control apparatus 10 may be likewise included in the corresponding control device 10, control method and computer program.

Various examples of the present disclosure relate to the control apparatus 10, the control device 10, the control method and to a corresponding computer program. These components are used to control one or more parameters of the hypervisor 100. Particularly, these components are used to control one or more parameters of the hypervisors 100 that affect the performance of the two or more virtual machines 200. The proposed concept may control the one or more parameters of the hypervisor with the aim of achieving the respective performance targets of the two or more virtual machines 200. Therefore, the one or more parameters may be adapted such, that the resulting performance of the two or more virtual machines 200 meets the performance targets of the virtual machines. This is achieved using an automated iterative process that determines the performance of the two or more virtual machines using a benchmark, uses the results of the benchmark to adjust the one or more parameters, and repeats the process until the termination condition is met (e.g., until the performance targets of all of the virtual machines are met, or until a time scheduled for the process has elapsed).

The proposed concept is based on performance targets of the two or more virtual machines. Accordingly, the circuitry of the control apparatus is configured to obtain the information on the respective performance targets of the two or more virtual machines 200 being hosted by the hypervisor. For example, the information on the respective performance targets may be received from the two or more virtual machines. For example, the information on the respective performance targets may be part of a configuration of the two or more virtual machines. Alternatively or additionally, the information on the respective performance targets may be obtained from an administrator of the hypervisor/server. For example, the information on the respective performance targets may be defined via a graphical user interface of the control apparatus 10 or of the hypervisor 100.

The iterative process starts from one or more initial values. Accordingly, the circuitry is configured to set the one or more parameters of the hypervisor to the one or more initial values. For example, the one or more initial values may be set independent of the respective performances targets, i.e., the one or more initial values may be one or more initial values that are irrespective of the performances targets of the two or more virtual machines. Alternatively, the respective performance targets may be taken into account when setting the one or more initial values. In other words, the one or more initial values may be based on the respective performance targets of the two or more virtual machines. For example, the circuitry may be configured to obtain the one or more initial values from a local database or data storage, with the local database or data storage comprising different sets of one or more initial values for different performance targets or combinations of performance targets. Alternatively, the circuitry may be configured to obtain the one or more initial values from a remote server, based on the respective performance targets of the two or more virtual machines.

In the proposed concept, one or more parameters (i.e., the values set for the one or more parameters) are adjusted to attain the performance targets of the two or more virtual machines. In this context, the respective performance targets of the two or more virtual machines may depend on the type of virtual machines. For example, at least one of the two or more virtual machines may comprise a real-time operating system or a real-time application, i.e., an operating system or application that is expected to process data and/or provide a response in real time, i.e., with a deterministic and pre-defined maximal delay. For example, the performance target of a virtual machine comprising a real-time operating system or a real-time application may relate to a maximal delay in processing data and/or providing a response, which may be influenced by cache hits vs. cache misses (i.e., the size of the caches allocated to one or more cores tasked with running the virtual machine), context switching, additional latency due to operation reordering etc. Another virtual machine may be configured to provide a human-machine-interface (HMI), i.e., a graphical user interface. For example, the performance target of a virtual machine configured provide an HMI may relate to a “snappiness” of the HMI, which may be based on a graphics rendering performance of the virtual machine, which may be influenced by the amount of graphics memory allocated for the virtual machine and/or based on an operating frequency of the integrated graphics processing unit of the server.

There are various parameters that can be adjusted to tailor the performance of the hypervisor/server to the performance targets of the two or more virtual machines. For example, the one or more parameters may relate to one or more of an operating frequency of a central processing unit (CPU), an operating frequency of an integrated graphics processing unit (iGPU), an allocation of cores of the central processing unit (CPU), memory bandwidth allocation between cores of the central processing unit (CPU), and an allocation of cache between the cores of the central processing unit and the integrated graphics processing unit. For example, the operating frequency of the CPU may be increased to increase the overall computing performance of all cores (at the expense of increased power consumption). The operating frequency of the GPU may be increased o increased the graphics rendering performance (again, at the expense of increased power consumption). The allocation of cores of the CPU (to the two or more virtual machines) may be used to shift computational performance between virtual machines, e.g., to increase computational performance of one virtual machine at the expense of another virtual machine. The memory bandwidth allocation between the cores of the CPU may define the bandwidth, at which the respective cores, and therefore the virtual machines being run on the respective cores, can access memory. For example, the available bandwidth may be shifted between cores, e.g., to provide additional memory bandwidth (and therefore also data throughput from or to memory) to the cores running one of the virtual machines at the expense of the cores running another of the virtual machines. For example, the allocation of cache between the cores of the central processing unit and the integrated graphics processing unit may be used to address cache misses in the respective virtual machines. For example, if one of the virtual machines suffers from a high performance of cache misses, the CPU and/or GPU cores running the virtual machine may be allocated a higher proportion of the cache, at the expense of the cache performance of the cores running another virtual machines.

The proposed concept is based on a loop that includes setting/adjusting the one or more parameters, running a benchmark to determine the performance of the virtual machines, determining one or more parameters to use in a subsequent iteration of the loop, and repeating the loop. Once the initial parameter values are set, the benchmark is run to determine the performance of the virtual machines. In some cases, the respective virtual machines, i.e., the configuration of the virtual machines and/or the benchmark being run, may be adjusted to the one or more parameters being set. For example, the circuitry may be configured to provide information on the one or more parameters to the two or more virtual machines (e.g., separately for each virtual machine with at least one parameter of the one or more parameters that is relevant for the respective virtual machine). Accordingly, as shown in FIG. 1c, the method may comprise providing 122 information on the one or more parameters to the two or more virtual machines. The respective virtual machines may use the information on the one or more parameters to update the configuration of the respective virtual machines and/or to update a configuration of the benchmark. Once the one or more parameters are set (and optionally communicated to the virtual machines), the benchmark may be triggered by the control apparatus. In other words, the circuitry may be configured to trigger the two or more virtual machines to run the benchmark after adjusting the one or more settings. Accordingly, the method may comprise triggering 124 the two or more virtual machines to run the benchmark after adjusting the one or more settings. For example, the benchmark may be triggered to run concurrently in the two or more virtual machines.

In the proposed concept, a benchmark is used. In general, a benchmark is a piece of software or set of parameters or values that is designed to measure a performance. In this context, the performance being measured is the performance of the respective virtual machines, and in particular the performance of the two or more virtual machines while the two or more virtual machines are running the benchmark. For example, the benchmark may comprise one or more tasks for determining the performance of the two or more virtual machines with respect to the respective performance targets. For example, the benchmark may imitate the workload of the respective virtual machines. In other words, depending on the type of virtual machine, different tasks may be used by the benchmark to imitate the workload of the virtual machines. For example, the benchmark may comprise a performance measurement functionality, e.g., one or more of a time-measurement functionality (for determining the runtime of a task), a latency measurement functionality (for determining the latency of operations that are part of a task), a bandwidth measurement functionality (for determining the memory bandwidth, for example), and a cache error rate measurement functionality (for determining the ratio of cache hits vs. cache misses).

The circuitry is configured to obtain the respective results of the benchmark being run (i.e., executed) in the two or more virtual machines, with the results of the benchmark indicating the performance of the respective virtual machines with respect to the respective performance targets, and with the results of the benchmark being affected by the one or more parameters. For example, the respective results may comprise information on the measured performance of the one or more tasks of the benchmark. This measured performance is, in turn, based on the one or more parameters being set.

The one or more parameters are then adjusted with the aim of reaching the respective performance targets. In other words, the circuitry is configured to adjust the one or more parameters based on the results of the benchmark and based on the respective performance targets. In this context, not every parameter of the one or more parameters might be adjusted in each iteration. For example, in some iterations, only a subset of the one or more parameters may be adjusted. In particular, the circuitry may be configured to identify a discrepancy between the respective results of the benchmark and the respective performance targets, and to adjust a parameter of the one or more parameters that is known to contribute to the discrepancy. Accordingly, as shown in FIG. 1c, the method may comprise identifying 140 a discrepancy between the respective results of the benchmark and the respective performance targets and adjusting a parameter of the one or more parameters that is known to contribute to the discrepancy. For example, the results of the benchmark may be analyzed to identify the at least one of the one or more parameters that is known to have an effect on a performance component that contributes to the discrepancy. For example, as outlined above, if the discrepancy between the respective results of the benchmark and the respective performance targets relates to the overall computing performance (i.e., each or multiple of the virtual machines lack sufficient computing performance), the parameter being identified may relate to the operating frequency of the CPU. If the discrepancy between the respective results of the benchmark and the respective performance targets relates to the computing performance of one of the virtual machines (or a subset of the virtual machines), the parameter being identified may relate to the allocation of cores of the CPU of the server to the virtual machines. If the discrepancy between the respective results of the benchmark and the respective performance targets relates to the graphics rendering performance of a virtual machine, the parameter being identified may relate to the operating frequency of the GPU, to an allocation of graphics memory or to a cache allocation between CPU cores and GPU cores. If the discrepancy between the respective results of the benchmark and the respective performance targets relates to a memory bandwidth of one of the virtual machines, the parameter being identified may relate to the memory bandwidth allocation between the cores of the CPU. If the discrepancy between the respective results of the benchmark and the respective performance targets relates to a ratio between cache hits and cache misses, the parameter being identified may relate to the allocation of cache between the cores of the central processing unit and/or the integrated graphics processing unit. For example, a look up table or similar data structure may be used to identify the respective parameter or parameters based on the identified discrepancy.

In general, the proposed concept may attempt to reach the performance targets for all of the virtual machines. In other words, the circuitry may be configured to, if the two or more virtual machines have different performance targets, adjust the one or more parameters with the aim of meeting the different performance targets. To reach this aim, different strategies may be employed.

For example, the control apparatus may attempt to improve (e.g., optimize) the one or more parameters to improve the performance of the two or more virtual machines at the same time (i.e., in parallel). In other words, based on the results of the benchmark, and in particular the identified discrepancy, the one or more parameters may be adjusted with the aim of improving the performance of more than one of the virtual machines at the same time.

Alternatively, a serial approach may be taken. In other words, the circuitry may be configured to, in a first time interval, adjust the one or more parameters to meet the performance target of a first of the two or more virtual machines, and then, in a second interval after the performance target of the first virtual machine is met, adjust the one or more parameters with the aim of meeting a performance target of a second of the two or more virtual machines. In other words, the performance of the first virtual machine may be increased towards the performance target first (e.g., until it reaches or surpasses the performance target), and the performance of the second virtual machine may follow once the adjustment of the one or more parameters with respect to the first virtual machine is completed. After the second time interval, the performance target of an optional third virtual machine may be addressed in a third time interval. For example, a prioritization between virtual machines may be used to determine the first and the second (and third) virtual machine. For example, the circuitry may be configured to adjust the one or more parameter during the second time interval such that the performance target of the first virtual machine remains met. In other words, if the result of the benchmark indicate that the performance target of the first virtual machine is violated, the change of the respective parameter may be rolled back or adjusted with the aim of the performance target of the first virtual machine being met.

In general, there are different types of adjustments. Some adjustments may be made on the fly, such as adjustments regarding the operating frequency. Such adjustments might not require a reboot of the virtual machines (and of the hypervisor). In other words, the circuitry may be configured to adjust at least one parameter of the one or more parameters without requiring a reboot of the two or more virtual machines. Other adjustments may require a reboot of at least the virtual machines, such as the memory or cache allocation between virtual machines or cores. In other words, the circuitry may be configured to adjust at least one parameter of the one or more parameters that requires a reboot of the two or more virtual machines.

The above measures (i.e., setting/adjusting the one or more parameters, running the benchmark, and analyzing the results of the benchmark to determine updated one or more settings) are repeated until the termination condition is met. In general, the termination condition may be met when the performance targets of each of the virtual machines is met. In other words, the above process may be repeated until the performance targets of each of the virtual machines is met. Accordingly, the termination condition may be met when the performance targets of the two or more virtual machines are met. However, this might not always be feasible, as the resources of the server may be inadequate to satisfy all of the performance targets. In this case, the loop may be terminated after some time, e.g., after a predefined number of iterations or after a predefined amount of time. In other words, the termination condition may be met when a number of iterations reaches an iteration threshold or when a time elapsed reaches a time threshold.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the control apparatus 10, control device 10, control method and computer program are mentioned in connection with the proposed concept or one or more examples described above or below (e.g. FIG. 2a to 4). The control apparatus 10, control device 10, control method and computer program may comprise one or more additional optional features corresponding to one or more aspects of the proposed concept or one or more examples described above or below.

In the following, an apparatus 20, device 20, method and computer program for a corresponding component for controlling the two or more virtual machines 200 and running the respective benchmark is shown.

FIG. 2a shows a block diagram of an example of an apparatus 20 or device 20 for a virtual machine 200 being hosted by a hypervisor and of a virtual machine 200 comprising the apparatus 20 or device 20. The apparatus 20 comprises circuitry that is configured to provide the functionality of the apparatus 20. For example, the apparatus 20 may comprise interface circuitry 22, processing circuitry 24 and (optional) storage circuitry 26. For example, the processing circuitry 24 may be coupled with the interface circuitry 22 and with the storage circuitry 26. For example, the processing circuitry 24 may be configured to provide the functionality of the apparatus, in conjunction with the interface circuitry 22 (for exchanging information, e.g., with a hypervisor 200 or a control apparatus 10) and the storage circuitry (for storing information). Likewise, the device 20 may comprise means that is/are configured to provide the functionality of the device. The components of the device 20 are defined as component means, which may correspond to, or implemented by, the respective structural components of the apparatus 20. For example, the device 20 may comprise means for processing 24, which may correspond to or be implemented by the processing circuitry 24, means for communicating 22, which may correspond to or be implemented by the interface circuitry 22, and means for storing information 26, which may correspond to or be implemented by the storage circuitry 26.

The circuitry or means is/are configured to obtain information on one or more parameters of the hypervisor from a control apparatus 10 (as shown in FIG. 1a) for controlling the one or more parameters of a hypervisor. The circuitry or means is/are configured to run a benchmark to determine a result of the benchmark. The result of the benchmark indicates a performance of the virtual machine with respect to a respective performance target of the virtual machine. The result of the benchmark is affected by the one or more parameters. The circuitry or means is/are configured to provide the result of the benchmark to the control apparatus. The circuitry or means may be configured to repeat obtaining the information on the one or more parameters, running the benchmark, and providing the result of the benchmark until a termination condition is met.

FIG. 2b shows a flow chart of an example of a corresponding method for a virtual machine. For example, the method may be performed by the virtual machine, e.g., by an application being executed within the virtual machine. The method comprises obtaining 210 the information on the one or more parameters of the hypervisor from the controller for controlling the one or more parameters of a hypervisor. The method comprises running 220 the benchmark to determine the result of the benchmark. The method comprises providing 230 the result of the benchmark to the controller. The method may comprise repeating 240 obtaining the information on the one or more parameters, running the benchmark, and providing the result of the benchmark until the termination condition is met.

In the following, the functionality of the apparatus 20, the device 20, the method and of a corresponding computer program is introduced in connection with the apparatus 20. Features introduced in connection with the apparatus 20 may be likewise included in the corresponding device 20, method and computer program.

As is evident from the features introduced above, the apparatus 20, device 20, method and computer program introduced in connection with FIGS. 2a and 2b are the counterpart to the control apparatus 10, control device 10, control method and computer program (short: controller) introduced in connection with FIGS. 1a to 1c. They serve to adjust the virtual machine to the one or more parameters being set by the controller (such as one or more of an operating frequency of a central processing unit, an operating frequency of an integrated graphics processing unit, an allocation of cores of the central processing unit, memory bandwidth allocation between cores of the central processing unit, and an allocation of cache between the cores of the central processing unit and the integrated graphics processing unit), run the benchmark, and report the results of the benchmark back to the controller. For example, the circuitry may be configured to perform the one or more tasks of the benchmark, to measure the performance of the one or more tasks and/or of the virtual machine or server while running the one or more tasks, and to compile the result of the benchmark. For example, the controller may provide the information on the one or more parameters, which the circuitry then applies to the virtual machine and/or to the benchmark. Then, the controller may trigger the benchmark (e.g., explicitly by transmitting a trigger signal or implicitly by providing the information on the one or more parameters). The circuitry may be configured to, based on the trigger provided by the controller, run (i.e., execute) the benchmark, to compile the result of the benchmark, and to provide the result of the benchmark to the controller.

The circuitry is configured to repeat obtaining the information on the one or more parameters, running the benchmark, and providing the result of the benchmark until the termination condition is met. For example, the controller may be configured to determine whether the termination condition is met and instruct the apparatus 20/virtual machine 200 accordingly, e.g., by instructing the apparatus 20 to abort the benchmark, or by refraining from adjusting the one or more parameters.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processing circuitry 24 or means for processing 24 may be implemented using one or more processing units, one or more processing devices, any means for processing, such as a processor, a computer or a programmable hardware component being operable with accordingly adapted software. In other words, the described function of the processing circuitry 24 or means for processing may as well be implemented in software, which is then executed on one or more programmable hardware components. Such hardware components may comprise a general purpose processor, a Digital Signal Processor (DSP), a micro-controller, etc.

For example, the storage circuitry 26 or means for storing information 26 may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 20, device 20, method and computer program are mentioned in connection with the proposed concept or one or more examples described above or below (e.g. FIG. 1a to 1c, 3 to 4). The apparatus 20, device 20, method and computer program may comprise one or more additional optional features corresponding to one or more aspects of the proposed concept or one or more examples described above or below.

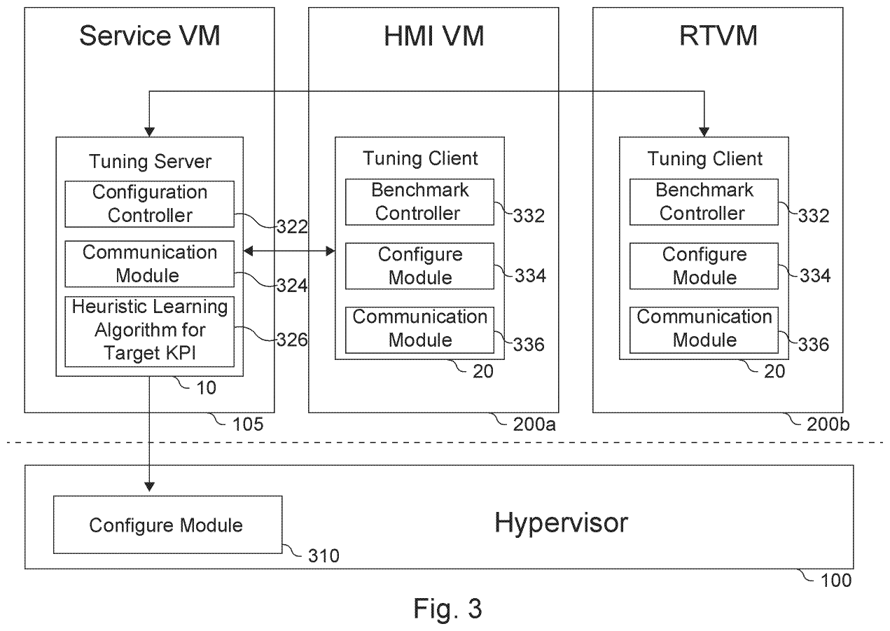

In the following, an example of the proposed concept is shown. FIG. 3 shows a schematic diagram of a high-level system overview. In the example, the proposed concept a tuning server (e.g., the control apparatus 10 or control device 10 of FIG. 1c) that is part of a service OS (Service Operating System, SOS) 105 (e.g., the service VM), tuning clients 20 (such as the apparatus 20 or device 20 of FIG. 2a) in the HMI VM 200a, the RTVM 200b or other VMs, and a configure module 310 in the VMM/hypervisor 100. In an example, the tuning server 10 comprises a configuration controller 322, a communication module 324 and a heuristic learning algorithm for the target KPI (Key Performance Indicators, i.e., the performance targets). The tuning clients 20 may comprise a benchmark controller 332, a configure module 334 and a communication module 336. The Tuning clients 20 communicate with the tuning server 10, e.g., via the respective communication modules. The tuning server 10 controls the configure module 310 of the hypervisor 100.

The tuning server 10 controls the clients' 20 and hypervisor's 105 initial and subsequent parameters. The clients 20 respond to set the parameters and run the benchmarks to profile the performance data and send the result of the benchmarks back to the server 10. The server decides on the next step (i.e., the subsequent parameters) based on the performance data that is generated based on the previous parameters, to start another cycle of setting the parameters and profiling the performance, or to report the final configurations. The process can be automatic or self-adaptive for the target KPIs.

The proposed concept can support the server manufacturer or the user in balancing the different KPIs (i.e., performance targets) across different domains in the WLC system. It may be self-adaptive and save the developers time required for tuning the parameters.

In the following, an example of the self-adaptive tunning flow is given.

Initially, the tuning server in the SOS (service VM), sets the initial KPIs (performance targets) for the target VMs, and sets initial parameters to the VMM and to the VMs (e.g., the HMI VM/RTVM). The communication channel between the VMs can be socket or virtual-UART (Universal Asynchronous Receiver Transmitter), for example. Subsequently, the VMM sets the system related parameters, like CAT (cache allocation) for each core of the VMs. The tuning clients in the VMs receive the parameters from the server and set the parameters in the benchmark. After running the benchmark, the profiling performance data (i.e., the result of the benchmark) is collected, and sent back to the server. The tuning server receives the performance data (i.e., the result of the benchmark), compares the performance data with the target objectives (KPIs) and decides on the next course of action (for example, by performing a small step parameter adjustment). If other parameters need to be retried, it will repeat the above-mentioned tasks. If the server determines suitable parameters or a timeout, it may output a report of configurations for reference, and stop the process.

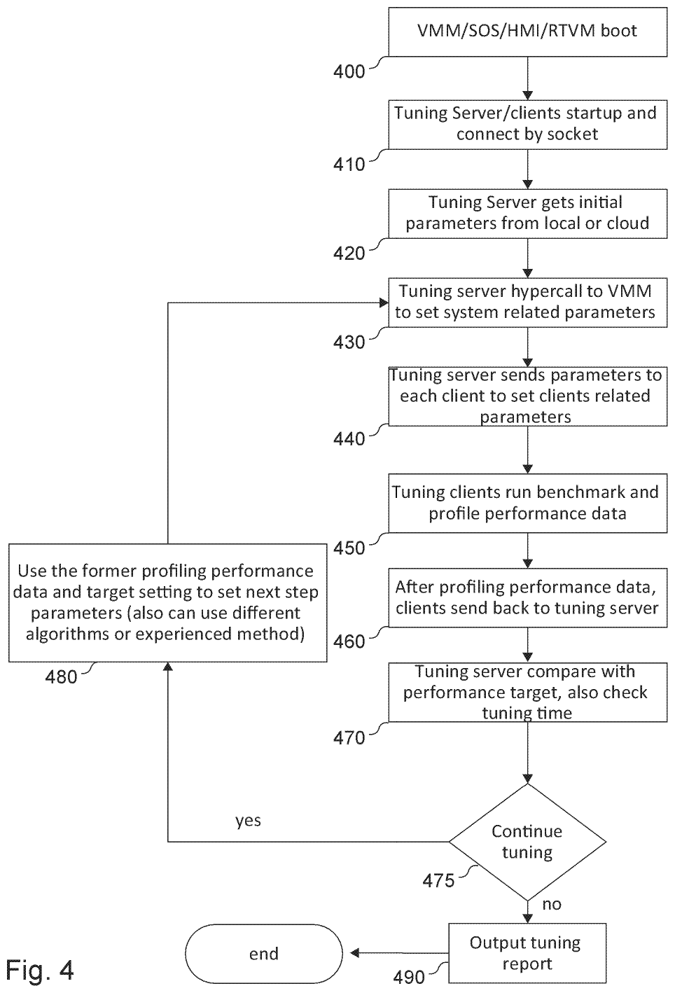

FIG. 4 shows a flow chart of an example of a tuning workflow. In the tuning workflow, the VMM, the SOS, the HMI and the RTVM boot 400. The tuning server and the tuning clients start up and connect 410, e.g., via socket. The tuning server obtains 420 the initial parameters, e.g., locally or from the cloud. The tuning server sends 430 a hypercall to the VMM to set the system-related parameters. The tuning server sends 440 the parameters to each (tuning) client to set the client-related parameters. The tuning clients run 450 the benchmark and profile the performance data. After profiling the performance data, the (tuning) clients send 460 the data back to the server. The tuning server compares 470 the performance data with the performance target and check the tuning time. Then, a determination is made on whether to continue tuning 475. If the performance data matches the performance target or the time for tuning has elapsed (i.e., if the termination condition is met), the tuning is (deemed) completed, a tuning report is output 490 and the workflow ends. If the performance data does not match the performance target and the time for tuning has not elapsed, the former profiling performance data and target setting is used to set 480 the next step (i.e., subsequent) parameters, i.e., to adjust the one or more parameters. For example, different algorithms or experienced methods may be used.

The next step parameters setting (i.e., adjusting the one or more parameters) is a major component of the self-adaptive tuning. The performance data may be harvested for clues on how to adjust the parameters. For example, if too many LLC (Last-Level Cache) cache misses occur in the RTVM, the size of the cache may be extended for the RT core (i.e., the core being used to execute the RTVM). For example, it can be set 1 way as one step adjustment.

In some examples, the KPI of one VM, such as the RTVM, may be filled first, and then an attempt may be made at filling the KPI of a second VM, such as the HMI VM. For example, a higher GPU frequency may be used to increase the performance of the HMI to reach the KPI. At the same time, the concept may make sure that the KPI of the first VM (RTVM) is not impacted.

After basic rules setting, the whole process can be self-adaptive. It may fail if finally no parameters can fill all the KPIs at the same time. A detailed report of the parameters and/or the process may be exported for reference.

More details and aspects of the process are mentioned in connection with the proposed concept or one or more examples described above or below (e.g. FIG. 1a to 2b). The process may comprise one or more additional optional features corresponding to one or more aspects of the proposed concept or one or more examples described above or below.

In the following, some examples of the proposed concept are presented.

An example (e.g., example 1) relates to a control apparatus (10) for controlling one or more parameters of a hypervisor (100), the control apparatus comprising circuitry configured to obtain information on respective performance targets of two or more virtual machines (200) being hosted by the hypervisor. The circuitry is configured to set the one or more parameters of the hypervisor to one or more initial values. The circuitry is configured to obtain respective results of a benchmark being run in the two or more virtual machines, the results of the benchmark indicating a performance of the respective virtual machines with respect to the respective performance targets, with the results of the benchmark being affected by the one or more parameters. The circuitry is configured to adjust the one or more parameters based on the results of the benchmark and based on the respective performance targets.

Another example (e.g., example 2) relates to a previously described example (e.g., example 1) or to any of the examples described herein, further comprising that the one or more parameters relate to one or more of an operating frequency of a central processing unit, an operating frequency of an integrated graphics processing unit, an allocation of cores of the central processing unit, memory bandwidth allocation between cores of the central processing unit, and an allocation of cache between the cores of the central processing unit and the integrated graphics processing unit.

Another example (e.g., example 3) relates to a previously described example (e.g., one of the examples 1 to 2) or to any of the examples described herein, further comprising that the circuitry is configured to repeat obtaining the respective results of the benchmark and adjusting the one or more parameters until a termination condition is met.

Another example (e.g., example 4) relates to a previously described example (e.g., example 3) or to any of the examples described herein, further comprising that the termination condition is met when the performance targets of the two or more virtual machines are met.’, or when a number of iterations reaches an iteration threshold, or when a time elapsed reaches a time threshold.

Another example (e.g., example 5) relates to a previously described example (e.g., one of the examples 1 to 4) or to any of the examples described herein, further comprising that the circuitry is configured to identify a discrepancy between the respective results of the benchmark and the respective performance targets, and to adjust a parameter of the one or more parameters that is known to contribute to the discrepancy.

Another example (e.g., example 6) relates to a previously described example (e.g., one of the examples 1 to 5) or to any of the examples described herein, further comprising that the circuitry is configured to, if the two or more virtual machines have different performance targets, adjust the one or more parameters with the aim of meeting the different performance targets.

Another example (e.g., example 7) relates to a previously described example (e.g., example 6) or to any of the examples described herein, further comprising that the circuitry is configured to, in a first time interval, adjust the one or more parameters to meet the performance target of a first of the two or more virtual machines, and then, in a second interval after the performance target of the first virtual machine is met, adjust the one or more parameters with the aim of meeting a performance target of a second of the two or more virtual machines.

Another example (e.g., example 8) relates to a previously described example (e.g., example 7) or to any of the examples described herein, further comprising that the circuitry is configured to adjust the one or more parameter during the second time interval such that the performance target of the first virtual machine remains met.

Another example (e.g., example 9) relates to a previously described example (e.g., one of the examples 1 to 8) or to any of the examples described herein, further comprising that the circuitry is configured to provide information on the one or more parameters to the two or more virtual machines.

Another example (e.g., example 10) relates to a previously described example (e.g., one of the examples 1 to 9) or to any of the examples described herein, further comprising that the circuitry is configured to trigger the two or more virtual machines to run the benchmark after adjusting the one or more settings.

Another example (e.g., example 11) relates to a previously described example (e.g., one of the examples 1 to 10) or to any of the examples described herein, further comprising that the circuitry is configured to adjust at least one parameter of the one or more parameters without requiring a reboot of the two or more virtual machines.

Another example (e.g., example 12) relates to a previously described example (e.g., one of the examples 1 to 11) or to any of the examples described herein, further comprising that the circuitry is configured to adjust at least one parameter of the one or more parameters that requires a reboot of the two or more virtual machines.

Another example (e.g., example 13) relates to a previously described example (e.g., one of the examples 1 to 12) or to any of the examples described herein, further comprising that the one or more initial values are based on the respective performance targets of the two or more virtual machines.

Another example (e.g., example 14) relates to a previously described example (e.g., one of the examples 1 to 13) or to any of the examples described herein, further comprising that the functionality of the control apparatus is provided by a further virtual machine (105) being hosted by the hypervisor.

An example (e.g., example 15) relates to an apparatus (20) for a virtual machine (200) being hosted by a hypervisor (100), the apparatus comprising circuitry configured to obtain information on one or more parameters of the hypervisor from a control apparatus (10) for controlling the one or more parameters of a hypervisor. The circuitry is configured to run a benchmark to determine a result of the benchmark, the result of the benchmark indicating a performance of the virtual machine with respect to a respective performance target of the virtual machine, with the result of the benchmark being affected by the one or more parameters. The circuitry is configured to provide the result of the benchmark to the control apparatus.

Another example (e.g., example 16) relates to a previously described example (e.g., example 15) or to any of the examples described herein, further comprising that the circuitry is configured to repeat obtaining the information on the one or more parameters, running the benchmark, and providing the result of the benchmark until a termination condition is met. An example (e.g., example 17) relates to a system comprising the control apparatus (10) according to one of the examples 1 to 14 and a hypervisor (100).

Another example (e.g., example 18) relates to a previously described example (e.g., example 17) or to any of the examples described herein, further comprising that the system further comprises two or more apparatuses (20) according to one of the examples 15 or 16.

Another example (e.g., example 19) relates to a previously described example (e.g., one of the examples 17 or 18) or to any of the examples described herein, further comprising that the two or more apparatuses according to one of the examples 15 or 16 are implemented in two or more virtual machines (200) being hosted by the hypervisor.

An example (e.g., example 20) relates to a system comprising the control apparatus (10) according to one of the examples 1 to 14 and two or more apparatuses (20) according to one of the examples 15 or 16.

An example (e.g., example 21) relates to a control device (10) for controlling one or more parameters of a hypervisor (100), the control device comprising means configured to obtain information on respective performance targets of two or more virtual machines (200) being hosted by the hypervisor. The means is configured to set the one or more parameters of the hypervisor to one or more initial values. The means is configured to obtain respective results of a benchmark being run in the two or more virtual machines, the results of the benchmark indicating a performance of the respective virtual machines with respect to the respective performance targets, with the results of the benchmark being affected by the one or more parameters. The means is configured to adjust the one or more parameters based on the results of the benchmark and based on the respective performance targets.

Another example (e.g., example 22) relates to a previously described example (e.g., example 21) or to any of the examples described herein, further comprising that the one or more parameters relate to one or more of an operating frequency of a central processing unit, an operating frequency of an integrated graphics processing unit, an allocation of cores of the central processing unit, memory bandwidth allocation between cores of the central processing unit, and an allocation of cache between the cores of the central processing unit and the integrated graphics processing unit.

Another example (e.g., example 23) relates to a previously described example (e.g., one of the examples 21 to 22) or to any of the examples described herein, further comprising that the means is configured to repeat obtaining the respective results of the benchmark and adjusting the one or more parameters until a termination condition is met, and that the termination condition is met when the performance targets of the two or more virtual machines are met.

Another example (e.g., example 24) relates to a previously described example (e.g., one of the examples 21 to 23) or to any of the examples described herein, further comprising that the means is configured to repeat obtaining the respective results of the benchmark and adjusting the one or more parameters until a termination condition is met, and that the termination condition is met when a number of iterations reaches an iteration threshold or when a time elapsed reaches a time threshold.

Another example (e.g., example 25) relates to a previously described example (e.g., one of the examples 21 to 24) or to any of the examples described herein, further comprising that the means is configured to identify a discrepancy between the respective results of the benchmark and the respective performance targets, and to adjust a parameter of the one or more parameters that is known to contribute to the discrepancy.

Another example (e.g., example 26) relates to a previously described example (e.g., one of the examples 21 to 25) or to any of the examples described herein, further comprising that the means is configured to, if the two or more virtual machines have different performance targets, adjust the one or more parameters with the aim of meeting the different performance targets.

Another example (e.g., example 27) relates to a previously described example (e.g., example 26) or to any of the examples described herein, further comprising that the means is configured to, in a first time interval, adjust the one or more parameters to meet the performance target of a first of the two or more virtual machines, and then, in a second interval after the performance target of the first virtual machine is met, adjust the one or more parameters with the aim of meeting a performance target of a second of the two or more virtual machines.

Another example (e.g., example 28) relates to a previously described example (e.g., example 27) or to any of the examples described herein, further comprising that the means is configured to adjust the one or more parameter during the second time interval such that the performance target of the first virtual machine remains met.

Another example (e.g., example 29) relates to a previously described example (e.g., one of the examples 21 to 28) or to any of the examples described herein, further comprising that the means is configured to provide information on the one or more parameters to the two or more virtual machines.

Another example (e.g., example 30) relates to a previously described example (e.g., one of the examples 21 to 29) or to any of the examples described herein, further comprising that the means is configured to trigger the two or more virtual machines to run the benchmark after adjusting the one or more settings.

Another example (e.g., example 31) relates to a previously described example (e.g., one of the examples 21 to 30) or to any of the examples described herein, further comprising that the means is configured to adjust at least one parameter of the one or more parameters without requiring a reboot of the two or more virtual machines.

Another example (e.g., example 32) relates to a previously described example (e.g., one of the examples 21 to 31) or to any of the examples described herein, further comprising that the means is configured to adjust at least one parameter of the one or more parameters that requires a reboot of the two or more virtual machines.

Another example (e.g., example 33) relates to a previously described example (e.g., one of the examples 21 to 32) or to any of the examples described herein, further comprising that the one or more initial values are based on the respective performance targets of the two or more virtual machines.

Another example (e.g., example 34) relates to a previously described example (e.g., one of the examples 21 to 33) or to any of the examples described herein, further comprising that the functionality of the control device is provided by a further virtual machine being hosted by the hypervisor.

An example (e.g., example 35) relates to a device (20) for a virtual machine (200) being hosted by a hypervisor (100), the device comprising means configured to obtain information on one or more parameters of the hypervisor from a control device (10) for controlling the one or more parameters of a hypervisor. The means is configured to run a benchmark to determine a result of the benchmark, the result of the benchmark indicating a performance of the virtual machine with respect to a respective performance target of the virtual machine, with the result of the benchmark being affected by the one or more parameters. The means is configured to provide the result of the benchmark to the control device.

Another example (e.g., example 36) relates to a previously described example (e.g., example 35) or to any of the examples described herein, further comprising that the means is configured to repeat obtaining the information on the one or more parameters, running the benchmark, and providing the result of the benchmark until a termination condition is met.

An example (e.g., example 37) relates to a system comprising the control device according to one of the examples 21 to 34 and a hypervisor.

Another example (e.g., example 38) relates to a previously described example (e.g., example 37) or to any of the examples described herein, further comprising that the system further comprises two or more devices according to one of the examples 35 or 36.

Another example (e.g., example 39) relates to a previously described example (e.g., one of the examples 37 or 38) or to any of the examples described herein, further comprising that the two or more devices according to one of the examples 35 or 36 are implemented in two or more virtual machines being hosted by the hypervisor.

An example (e.g., example 40) relates to a system comprising the control device according to one of the examples 21 to 34 and two or more devices according to one of the examples 35 or 36.

An example (e.g., example 41) relates to a control method for controlling one or more parameters of a hypervisor (100), the control method comprising obtaining (110) information on respective performance targets of two or more virtual machines being hosted by the hypervisor. The control method comprises setting (120) the one or more parameters of the hypervisor to one or more initial values. The control method comprises obtaining (130) respective results of a benchmark being run in the two or more virtual machines, the results of the benchmark indicating a performance of the respective virtual machines with respect to the respective performance targets, with the results of the benchmark being affected by the one or more parameters. The control method comprises adjusting (150) the one or more parameters based on the results of the benchmark and based on the respective performance targets.

Another example (e.g., example 42) relates to a previously described example (e.g., example 41) or to any of the examples described herein, further comprising that the one or more parameters relate to one or more of an operating frequency of a central processing unit, an operating frequency of an integrated graphics processing unit, an allocation of cores of the central processing unit, memory bandwidth allocation between cores of the central processing unit, and an allocation of cache between the cores of the central processing unit and the integrated graphics processing unit.

Another example (e.g., example 43) relates to a previously described example (e.g., one of the examples 41 to 42) or to any of the examples described herein, further comprising that the control method comprises repeating (160) obtaining (130) the respective results of the benchmark and adjusting (150) the one or more parameters until a termination condition is met, and the termination condition is met when the performance targets of the two or more virtual machines are met.

Another example (e.g., example 44) relates to a previously described example (e.g., one of the examples 41 to 43) or to any of the examples described herein, further comprising that the control method comprises repeating (160) obtaining (130) the respective results of the benchmark and adjusting (150) the one or more parameters until a termination condition is met, and the termination condition is met when a number of iterations reaches an iteration threshold or when a time elapsed reaches a time threshold.

Another example (e.g., example 45) relates to a previously described example (e.g., one of the examples 41 to 44) or to any of the examples described herein, further comprising that the method comprises identifying (140) a discrepancy between the respective results of the benchmark and the respective performance targets and adjusting a parameter of the one or more parameters that is known to contribute to the discrepancy.

Another example (e.g., example 46) relates to a previously described example (e.g., one of the examples 41 to 45) or to any of the examples described herein, further comprising that the method comprises, if the two or more virtual machines have different performance targets, adjusting the one or more parameters with the aim of meeting the different performance targets.

Another example (e.g., example 47) relates to a previously described example (e.g., example 46) or to any of the examples described herein, further comprising that the method comprises, in a first time interval, adjusting the one or more parameters to meet the performance target of a first of the two or more virtual machines, and then, in a second interval after the performance target of the first virtual machine is met, adjusting the one or more parameters with the aim of meeting a performance target of a second of the two or more virtual machines.

Another example (e.g., example 48) relates to a previously described example (e.g., example 47) or to any of the examples described herein, further comprising that the method comprises adjusting the one or more parameter during the second time interval such that the performance target of the first virtual machine remains met.

Another example (e.g., example 49) relates to a previously described example (e.g., one of the examples 41 to 48) or to any of the examples described herein, further comprising that the method comprises providing (122) information on the one or more parameters to the two or more virtual machines.

Another example (e.g., example 50) relates to a previously described example (e.g., one of the examples 41 to 49) or to any of the examples described herein, further comprising that the method comprises triggering (124) the two or more virtual machines to run the benchmark after adjusting the one or more settings.

Another example (e.g., example 51) relates to a previously described example (e.g., one of the examples 41 to 50) or to any of the examples described herein, further comprising that the method comprises adjusting at least one parameter of the one or more parameters without requiring a reboot of the two or more virtual machines.

Another example (e.g., example 52) relates to a previously described example (e.g., one of the examples 41 to 51) or to any of the examples described herein, further comprising that the method comprises adjusting at least one parameter of the one or more parameters that requires a reboot of the two or more virtual machines.

Another example (e.g., example 53) relates to a previously described example (e.g., one of the examples 41 to 52) or to any of the examples described herein, further comprising that the one or more initial values are based on the respective performance targets of the two or more virtual machines.

Another example (e.g., example 54) relates to a previously described example (e.g., one of the examples 41 to 53) or to any of the examples described herein, further comprising that the control method is performed by a further virtual machine being hosted by the hypervisor.

An example (e.g., example 55) relates to a method for a virtual machine being hosted by a hypervisor, the method comprising obtaining (210) information on one or more parameters of the hypervisor from a controller for controlling the one or more parameters of a hypervisor.

The method comprises running (220) a benchmark to determine a result of the benchmark, the result of the benchmark indicating a performance of the virtual machine with respect to a respective performance target of the virtual machine, with the result of the benchmark being affected by the one or more parameters. The method comprises providing (230) the result of the benchmark to the controller.

Another example (e.g., example 56) relates to a previously described example (e.g., example 55) or to any of the examples described herein, further comprising that the method comprises repeating (240) obtaining the information on the one or more parameters, running the benchmark, and providing the result of the benchmark until a termination condition is met.

An example (e.g., example 57) relates to a combined method comprising the method according to one of the examples 41 to 54 and the method according to one of the examples 55 or 56.

An example (e.g., example 58) relates to a machine-readable storage medium including program code, when executed, to cause a machine to perform the method of one of the examples 41 to 54, the method according to one of the examples 55 or 56, or the method according to example 57.

An example (e.g., example 59) relates to a computer program having a program code for performing the method of one of the examples 41 to 54, the method according to one of the examples 55 or 56, or the method according to example 57 when the computer program is executed on a computer, a processor, or a programmable hardware component.

An example (e.g., example 60) relates to a machine-readable storage including machine readable instructions, when executed, to implement a method or realize an apparatus as claimed in any pending claim or shown in any apparatus.

More details and aspects of the self-adaptive tuning method are mentioned in connection with the proposed concept or one or more examples described above or below (e.g. FIG. 1a to 2b).

The self-adaptive tuning method may comprise one or more additional optional features corresponding to one or more aspects of the proposed concept or one or more examples described above or below.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A caching apparatus comprising:
an interface for communicating with one or more cloud gaming instances;
processing circuitry configured to:
obtain requests for cached transcoded versions of textures to be used in the one or more cloud gaming instances, and
provide the cached transcoded versions of the textures to the one or more cloud gaming instances.

2. The caching apparatus according to claim 1, wherein the processing circuitry is configured to cache the transcoded versions of the textures in a memory circuitry and/or a storage circuitry of the caching apparatus.

3. The caching apparatus according to claim 1, wherein the cached transcoded versions of the textures are transcoded versions of textures being included in games being executed in the one or more cloud gaming instances.

4. The caching apparatus according to claim 1, wherein the cached transcoded versions are transcoded into a format that is supported by a graphics processing unit of a computer system being used to host the one or more cloud gaming instances.

5. The caching apparatus according to claim 1, wherein the requests comprise identifiers for identifying the respective texture to be provided, and the cached transcoded versions are provided based on the identifiers included in the requests.

6. The caching apparatus according to claim 1, wherein the requests comprise information on a desired format of the transcoded version, and wherein the cached transcoded versions are provided based on the information on the desired format.

7. The caching apparatus according to claim 1, wherein the processing circuitry is configured to obtain information on one or more games being executed in the one or more cloud gaming instances, and to obtain the transcoded versions of the textures for caching based on the information on the one or more games being executed in the one or more cloud gaming instances.

8. The caching apparatus according to claim 7, wherein the processing circuitry is configured to obtain the transcoded versions of the textures from a separate transcoding apparatus.

9. The caching apparatus according to claim 8, wherein the processing circuitry is configured to request the transcoded versions of the textures based on identifiers for identifying the respective textures to be provided and/or based on a desired format of the textures.

10. The caching apparatus according to claim 9, wherein the processing circuitry is configured to determine the desired format of the textures based on a texture format being supported by a graphics processing unit of a computer system being used to host the one or more cloud gaming instances.

11. The caching apparatus according to claim 7, wherein the processing circuitry is configured to obtain the transcoded versions of the textures by transcoding the textures being included in games being executed in the one or more cloud gaming instances.

12. The caching apparatus according to claim 7, wherein the information on the one or more games being executed in the one or more cloud gaming instances is obtained within the requests or wherein the information on the one or more games being executed in the one or more cloud gaming instances is obtained separately from the requests.

13. The caching apparatus according to claim 1, wherein the processing circuitry is configured to provide the transcoded versions to a texture load unit of a user space graphics driver being executed in the respective cloud gaming instance.

14. A driver apparatus for a cloud gaming instance, the driver apparatus comprising:
an interface for communicating with a caching apparatus;
processing circuitry to:
provide a graphics driver functionality for a game being executed in the cloud gaming instance,
obtain an instruction for loading a texture included in the game,
request a transcoded version of the texture to be loaded from the caching apparatus,
obtain the transcoded version of the texture from the caching apparatus, and
load the transcoded versions of the texture.

15. The driver apparatus according to claim 14, wherein the transcoded version of the texture is a transcoded version of a texture being included in the game, wherein the transcoded version of the texture is loaded instead of the texture included with the game.

16. The driver apparatus according to claim 14, wherein the transcoded version of the texture is transcoded into a format that is supported by the graphics processing unit of the computer system.

17. The driver apparatus according to claim 14, wherein the driver functionality is provided in user space.

18. A transcoding apparatus, comprising:
an interface for communicating with a caching apparatus; and
processing circuitry to:
transcode textures of a game to be executed in one or more cloud gaming instances,
obtain a request for a transcoded version of a texture from the caching apparatus, and
provide the transcoded version of the texture to the caching apparatus.

19. The transcoding apparatus according to claim 18, wherein the processing circuitry comprises one or more of a central processing unit, a graphics processing unit, a field-programmable gate array and an application-specific integrated circuit for transcoding, wherein one or more of the central processing unit, the graphics processing unit, the field-programmable gate array the application-specific integrated circuit for transcoding is used for transcoding the textures of the game.

20-25. (canceled)
